(19) United States
(12) Patent Application Publication
(10) Pub. No.: US 2021/0043362 A1
(43) Pub. Date: Feb. 11, 2021

(54) INDUCTOR

(71) Applicant: Murata Manufacturing Co., Ltd., Kyoto-fu (JP)

(72) Inventors: Yasutaka MIZUKOSHI, Nagaokakyo-shi (JP); Takeo OHAGA, Nagaokakyo-shi (JP); Masaki KITAJIMA, Nagaokakyo-shi (JP)

(73) Assignee: Murata Manufacturing Co., Ltd., Kyoto-fu (JP)

(21) Appl. No.: 16/987,249

(22) Filed: Aug. 6, 2020

(30) Foreign Application Priority Data
Aug. 8, 2019 (JP) 2019-146155

(51) Int. Cl. H01F 27/28; H01F 27/255; H01F 41/061; H01F 41/02

(52) U.S. Cl. CPC H01F 27/2823; H01F 41/0246; H01F 41/061; H01F 27/255

(57) ABSTRACT

An inductor that includes a coil having a winding portion in which a conductor having a coating layer is wound, and a pair of lead-out portions formed by leading out the conductor from the winding portion; and a magnetic portion including magnetic powder and resin and configured to seal the coil. The magnetic powder includes first particles having a first average particle diameter, and second particles having a second average particle diameter smaller than the first average particle diameter, and a thickness of the coating layer has a value larger than the second average particle diameter.

### CROSS-REFERENCE TO RELATED APPLICATION

This application claims benefit of priority to Japanese Patent Application No. 2019-146155, filed Aug. 8, 2019, the entire content of which is incorporated herein by reference.

### BACKGROUND

### Technical Field

The present disclosure relates to an inductor having a coil, and a magnetic portion for sealing the coil.

### Background Art

An inductor having a coil and a magnetic portion for sealing the coil has been widely used. There has been proposed a method of manufacturing an inductor in which a mixture of magnetic powder and resin is disposed around a coil, compressed, and subjected to pressure bonding to form a magnetic portion that seals the coil, as described, for example, in Japanese Unexamined Patent Application Publication No. 2009-246398.

However, when the mixture of the magnetic powder and the resin is disposed around the coil and compressed, particles of the magnetic powder enter a coating layer of a conductor of the coil, and an insulation property of the coil may be deteriorated. Accordingly, a dielectric strength voltage of the inductor is reduced, and a yield of the inductor during manufacturing is also reduced.

### SUMMARY

Thus, the present disclosure provides an inductor manufacturable at a high yield, and having sufficient pressure resistance.

An inductor according to one aspect of the present disclosure includes a coil having a winding portion in which a conductor having a coating layer is wound, and a pair of lead-out portions formed by leading out the conductor from the winding portion; and a magnetic portion including magnetic powder and resin and configured to seal the coil. The magnetic powder includes first particles having a first average particle diameter, and second particles having a second average particle diameter smaller than the first average particle diameter, and a thickness of the coating layer has a value larger than the second average particle diameter.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1A is a perspective view schematically illustrating an overview of an inductor according to one embodiment of the present disclosure;

FIG. 1B is a side cross-sectional view schematically illustrating a cross-section A-A in FIG. 1A;

FIG. 2 is a diagram illustrating a case where a particle of magnetic powder enters a coating layer of a conductor of a coil, in an inductor of the related art;

FIG. 3 is a diagram schematically illustrating an example of a thickness of a coating layer of a conductor in the inductor according to the one embodiment of the present disclosure; and

FIG. 4 is a graph illustrating a working example of the present disclosure, and is a graph showing a relationship between thickness and limit pressure resistance value of a coating layer.

### DETAILED DESCRIPTION

Hereinafter, an embodiment for implementing the present disclosure will be described with reference to the drawings. Note that, an inductor described below is intended to embody the technical idea of the present disclosure, and the present disclosure is not limited to the following, unless otherwise specified. In the drawings, members having the same function are denoted by the same reference numeral in some cases. Sizes, positional relationships, and the like of the members illustrated in the drawings are exaggerated in some cases for clarity of description.

Inductor According to One Embodiment

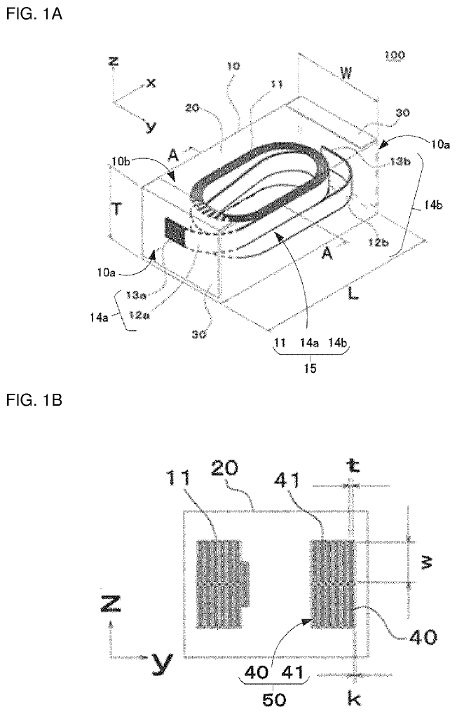

First, with reference to FIG. 1A and FIG. 1B, an inductor according to one embodiment of the present disclosure will be described. FIG. 1A is a perspective view schematically illustrating an overview of the inductor according to the one embodiment of the present disclosure. FIG. 1B is a side cross-sectional view schematically illustrating the cross-section A-A in FIG. 1A. In FIG. 1A and FIG. 1B, three orthogonal directions are indicated by an x-axis, a y-axis, and a z-axis, respectively. Note that, in FIG. 1A, an inside of a magnetic portion is drawn so as to be seen through.

An inductor 100 according to the present embodiment includes an element body 10 having a coil 15, and a magnetic portion 20 including magnetic powder and resin to seal the coil 15. The magnetic powder and the resin contain insulation-coated metal magnetic powder and a thermosetting resin having an insulation property, and the metal magnetic powder may be made by mixing different particle diameters, or may have a different composition. However, metal magnetic powder not insulation-coated may be used.

The element body 10 having the coil 15 and the magnetic portion 20 for sealing the coil 15 has a substantially rectangular parallelepiped appearance shape, and has a mounting surface, an upper surface facing the mounting surface, end surfaces perpendicular to the mounting surface and facing each other, and side surfaces perpendicular to a bottom surface and the end surfaces, and facing each other. A direction in which the end surfaces face each other is defined as a longitudinal direction (x-axis direction), a direction in which the side surfaces face each other is defined as a short-side direction (y-axis direction), and a direction in which the mounting surface and the upper surface face each other is defined as a height direction (z-axis direction). As a size of the element body 10, a case where a length L in the longitudinal direction is about 1.6 mm or more and about 3.2 mm or less (i.e., from about 1.6 mm to about 3.2 mm), a length W in the short-side direction is about 0.8 mm or more and about 2.5 mm or less (i.e., from about 0.8 mm to about 2.5 mm), and a height T is about 0.5 mm or more and about 2.5 mm or less (i.e., from about 0.5 mm to about 2.5 mm), can be exemplified, but the present disclosure is not limited thereto.

The magnetic portion 20 is made of a mixture of magnetic powder and resin. As will be described later, the magnetic powder includes first particles having a first average particle diameter, and second particles having a second average particle diameter smaller than the first average particle diameter.

A filling rate of the magnetic powder in the mixture of the magnetic powder and the resin is, for example, about 60% by weight or more, and preferably about 80% by weight or more. As the magnetic powder, iron based metal magnetic powder such as Fe, Fe—Si, Fe—Ni, Fe—Si—Cr, Fe—Si—Al, Fe—Ni—Al, Fe—Cr—Al, or Fe—Ni—Mo, metal magnetic powder having another composition system, metal magnetic powder such as amorphous, metal magnetic powder in which surfaces are coated with an insulator such as glass, metal magnetic powder in which surfaces are modified, or nano-level fine metal magnetic powder is used.

As the resin, a thermosetting resin such as an epoxy resin, a polyimide resin, or a phenol resin, a thermoplastic resin such as a polyethylene resin, or a polyamide resin, or the like is used.

The coil 15 is a coil in which a conductor 50, that is a flat rectangular wire having a substantially rectangular cross-section, is formed as a so-called α-winding. More specifically, the coil 15 includes a winding portion 11 in which the conductor (rectangular wire) 50 having a coating layer 41 around a metal portion 40 is wound as a spiral at two stages such that the two stages are linked to each other at an innermost periphery, and a pair of lead-out portions 14a and 14b formed by leading out the rectangular wire from outermost peripheries of the respective stages of the winding portion 11. In the present embodiment, a winding axis of the winding portion 11 of the coil 15 is disposed in the height direction (z-axis direction) of the element body 10, and the lead-out portions 14a and 14b forming the pair are led out to respective sides opposite to each other in the longitudinal direction (x-axis direction) of the element body 10.

However, the coil formed as the α-winding is merely an example, and a coil of any other structure, or a type may be adopted.

As dimensions of the metal portion 40 of the conductor (rectangular wire) 50 forming the coil 15, a case can be exemplified where a length w in a width direction is about 150 μm or more and about 600 μm or less (i.e., from about 150 μm to about 600 μm), and a thickness t is about 20 μm or more and about 200 μm or less (i.e., from about 20 μm to about 200 μm). Note that, a thickness k of the coating layer 41 of the conductor (rectangular wire) 50 will be described later. However, the conductor is not limited to the rectangular wire, and a round wire having a circular cross-section may be used, and a tip of the round wire may be crushed and flattened.

The lead-out portion 14a on one side of the coil 15 has a first region 12a, that is led out in the longitudinal direction of the element body from the outermost periphery of the stage on an upper side (side far from the mounting surface) of the winding portion 11, and a second region 13a, that is a tip portion linked to the first region 12a. Similarly, the lead-out portion 14b on another side has a first region 12b, that is led out in the longitudinal direction of the element body from the outermost periphery of the stage on a lower side (side close to the mounting surface) of the winding portion 11, and a second region 13b, that is a tip portion linked to the first region 12b. The first regions 12a and 12b are led out to the respective sides opposite to each other along the longitudinal direction (x-axis direction) of the element body, and the second regions 13a and 13b are disposed so as to be along end surfaces 10a on both sides, respectively.

At least a part of the coating layer of an outer surface of each of the second regions 13a and 13b disposed along the end surface 10a (a surface on an opposite side to the magnetic portion 20) is removed, and outer electrodes 30 are formed on the second region 13a with the coating layer removed, and on the second region 13b with the coating layer removed, respectively. In the illustrated example, the outer electrodes 30 are formed so as to extend on all of both the end surfaces 10a, respectively, and also on a mounting surface 10b of the element body 10. However, the present disclosure is not limited thereto, and the outer electrodes 30 may also be provided only on both the end surfaces 10a, respectively.

The outer electrodes 30 may be formed by applying a conductive paste to both the end surfaces 10a including the second regions 13a and 13b from which the respective coating layers are removed, and partial regions of the mounting surface 10b, or may be formed by performing a plating process.

Method of Manufacturing Inductor

Next, an example of a method of manufacturing the inductor 100 will be described.

Coil Forming Process

First, a coil forming process for forming the coil 15 will be described.

First, the conductor (rectangular wire) 50 having the coating layer 41 is prepared, and the conductor (rectangular wire) 50 is wound as the spiral at the two stages such that the two stages are linked to each other at the innermost periphery, thereby forming the winding portion 11. Then, the lead-out portion is led out from the outermost periphery of the upper stage of the winding portion 11, and the lead-out portion is led out from the outermost periphery of the lower stage, in respective directions opposite to each other, to form the first regions 12a and 12b. Further, the first regions 12a and 12b are made to be curved, and disposed such that wide surfaces of the respective second regions 13a and 13b are substantially parallel to each other.

Element Body Forming Process

In an element body forming process, the coil 15 that is prepared is embedded in a magnetic material formed of mixed powder of the magnetic powder and the resin, and the magnetic material is pressurized and heated, and is formed into a substantially rectangular parallelepiped shape. Accordingly, a winding axis of the winding portion 11 is disposed in the magnetic portion 20 so as to substantially perpendicularly intersect with the mounting surface 10b of the element body 10, and the element body 10 can be obtained in which the second region 13a of an end portion of the lead-out portion 14a is disposed along the end surface 10a of the element body, and the second region 13b of an end portion of the lead-out portion 14b is disposed along the end surface 10a of the element body. At this time, on the end surface 10a, the coating layer 41 on the wide surface of the second region 13a is exposed from the end surface 10a, and the other portion is embedded in the magnetic portion 20, and on the end surface 10a, the coating layer 41 on the wide surface of the second region 13b is exposed from the end surface 10a, and the other portion is embedded in the magnetic portion 20.

Protective Layer Forming Process

A protective layer having an insulation property is formed on a surface of the element body 10 that is formed, and in a region where the coating layer 41 is not exposed. The protective layer is formed, for example, by adding a thermosetting resin such as an epoxy resin, a polyimide resin, or a phenol resin, or a thermoplastic resin such as a polyethylene resin or a polyamide resin to a surface thereof, by a method such as application or dipping, and by solidifying the added resin as necessary.

Electrode Forming Process

Next, an electrode forming process for forming the outer electrode 30 will be described.

First, in a region where the outer electrode 30 is to be formed, the protective layer, and the coating layers 41 of each of the second regions 13a and 13b that is exposed to the end surface is removed. The removal of the coating layer and the like is performed by using a physical means such as laser, blast treatment, polishing, or the like. Next, the outer electrodes 30 are formed in the regions such as both the end surfaces 10a including the second regions 13a and 13b from which the respective coating layers are removed. The outer electrode 30 may be formed by applying a conductive paste. Further, Ni plating or Sn plating may be performed on the conductive paste.

In addition, the outer electrode may be formed by performing a plating process, without using conductive paste coating. In this case, a case can be exemplified where Cu plating is performed, Ni plating is performed on a Cu plating layer, and Sn plating is performed on the Ni plating.

The inductor and the method of manufacturing the inductor according to the present embodiment are merely examples, and an inductor having any other structure, or any type, and a method of manufacturing the same may be employed, as long as the inductor has a coil using a conductor in which a coating layer has a thickness as described below, and a magnetic portion sealing the coil and including magnetic powder and resin.

Thickness of Coating Layer

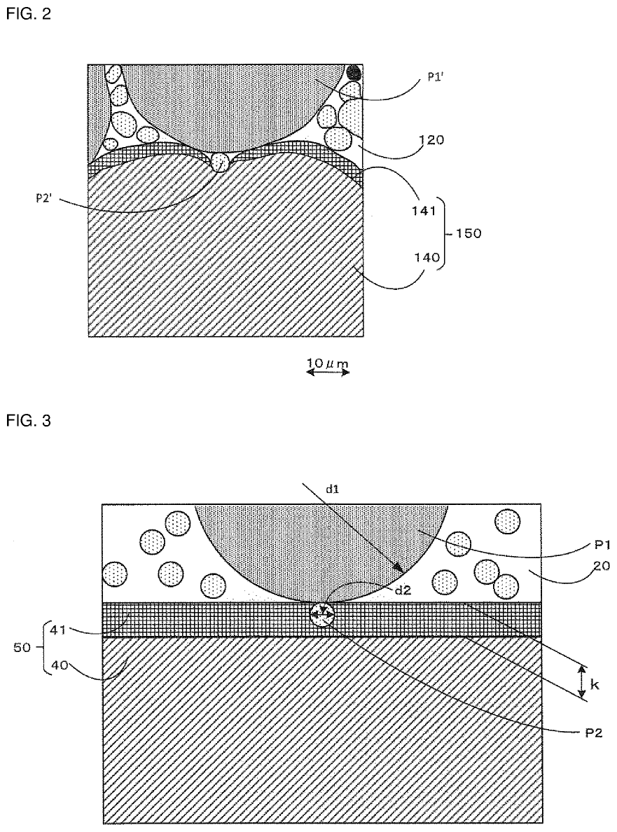

Next, with reference to FIG. 2 and FIG. 3, the thickness of the coating layer of the conductor in the inductor according to the one embodiment of the present disclosure will be described. FIG. 2 is a diagram illustrating a case where a particle of magnetic powder enters a coating layer of a conductor of a coil, in an inductor of the related art. FIG. 3 is a diagram schematically illustrating an example of the thickness of the coating layer of the conductor in the inductor according to the one embodiment of the present disclosure.

In an inductor that is integrally formed by sealing a coil formed by winding a conductor having a coating layer with a magnetic portion containing magnetic powder and resin, it is necessary to increase a filling rate of the magnetic powder in order to improve characteristics of the magnetic portion commencing with a magnetic permeability μ. For this reason, in many cases, a magnetic portion in which magnetic powder containing large particles and small particles is combined is used. Since the small particles fill gaps generated among the large particles, the filling rate can be improved. In order to further improve the filling rate, application of a high pressure during the formation of the magnetic portion is also performed.

However, it has been known that when the mixture of the magnetic powder and the resin disposed around the coil is compressed, the particles of the magnetic powder enter the coating layer of the conductor of the coil, and an insulation property of the coil deteriorates. Thereby, the dielectric strength voltage of the inductor is reduced, and a yield of the inductor during manufacturing is also reduced. In particular, when the large particles and the small particles are used as the magnetic powder, it is considered that when the magnetic powder is compressed, the small particle to which large force is applied from the large particle and that enters the coating layer of the conductor of the coil is a factor of the reduction in dielectric strength voltage.

This will be described by using FIG. 2 that is a diagram based on a micrograph of an inductor actually manufactured. In the inductor of the related art illustrated in FIG. 2, an average particle diameter of small particles p2′ is about 5 μm, and a thickness of a coating layer 141 of a conductor 150 is about 4 μm. That is, the thickness of the coating layer 141 of the conductor 150 of the coil has a value smaller than the average diameter of the small particle p2′ of the magnetic powder.

Thus, as illustrated in FIG. 2, the small particle p2′ applied with large force by a large particle p1′ breaks through the coating layer 141 of the conductor 150, and even reaches a metal portion 140. Thereby, an insulation property of the coil deteriorates.

Thickness of Coating Layer of Inductor According to One Embodiment

In the inductor 100 according to the one embodiment of the present disclosure, the magnetic powder includes first particles P1 having a first average particle diameter d1 and second particles P2 having a second average particle diameter d2 smaller than the first average particle diameter d1. As the first average particle diameter d1, about 50 μm may be exemplified, and as the second average particle diameter d2, about 5 μm may be exemplified. However, the present disclosure is not limited thereto, and as the first average particle diameter d1, a value of around 30 μm to around 90 μm may be exemplified, and as the second average particle diameter d2, a value of around 3 μm to around 15 μm may be exemplified.

In the present embodiment, as is clear from FIG. 3, the thickness k of the coating layer 41 has a value larger than the second average particle diameter d2 of the second particles P2. Accordingly, even if the second particle P2 is pressed by the first particle P1 and enters the coating layer 41, the first particle P1 does not reach the metal portion 40 of the conductor 50, and an insulation property of the coil 15 can be maintained.

As described above, by setting the thickness k of the coating layer 41 to a value larger than the second average particle diameter d2 of the second particles P2 that are the small particles, it is possible to suppress deterioration in insulation property of the coil 15, even when a high pressure is applied during the formation of the magnetic portion in order to increase a filling rate. Accordingly, it is possible to provide the inductor 100 manufacturable at a high yield and having sufficient pressure resistance.

In particular, in the present embodiment, since the rectangular wire is used as the conductor 50, occupancy (a space factor) of the metal portion 40 with respect to a cross-sectional area of the coil can be increased, and thus characteristics of the inductor 100 can be improved. On the other hand, the second particle P2 tends to easily enter the coating layer 41 of a wide surface due to a shape of the rectangular wire. However, by setting the thickness k of the coating layer 41 to a value larger than the second average particle diameter d2 of the second particles P2, it is possible to suppress the deterioration in insulation property of the coil 15, and thus, the thickness k of the coating layer 41 that is larger than the second average particle diameter d2 is particularly effective in the rectangular wire.

Numerical Range of Thickness of Coating Layer

When the thickness k of the coating layer 41 is described further specifically, the thickness of the coating layer 41, in general, can be formed with a tolerance in a range from about −1 μm to about +2 μm.

Based on a tolerance of −1 μm on a minus side, the thickness k of the coating layer 41 preferably has a value larger than the second average particle diameter d2 by about 1 μm or more. Since the thickness k of the coating layer 41 has a value larger than the second average particle diameter d2 by about 1 μm or more, even when a high pressure is applied during the formation of the magnetic portion in order to increase the filling rate, it is possible to more effectively suppress the deterioration in insulation property of the coil 15.

The second particles P2 are distributed with the second average particle diameter d2 as a peak, and a large number of the second particles P2 each have a particle diameter having a value close to the second average particle diameter d2. However, a possibility cannot be negated that the second particle P2 having a particle diameter larger than the second average particle diameter d2 to some extent is present. There is a possibility that the second particle P2 having such a large particle diameter is pressed by the first particle P1 and enters the coating layer 41. However, it is conceivable that a possibility that the second particle P2 having a large particle diameter unlikely to be present outside the peak is present in a very narrow region between the first particle P1 and the coating layer 41 during compression formation is low, and a possibility that the yield at the time of manufacturing is reduced is low.

Considering a safety margin based on particle size distribution of the second particles P2, it is more preferable that the thickness k of the coating layer 41 has a value larger than the second average particle diameter d2 by about 2 μm or more. Since the thickness k of the coating layer 41 has a value larger than the second average particle diameter d2 by about 2 μm or more, even when a high pressure is applied during the formation of the magnetic portion in order to increase the filling rate, it is possible to more effectively suppress the deterioration in insulation property of the coil 15.

Considering that the second average particle diameter d2 of the second particles P2 takes a variety of values (for example, about 3 μm to about 15 μm), it is also conceivable to manage the thickness k of the coating layer 41 by using a ratio with respect to the second average particle diameter d2. For example, by setting the thickness k of the coating layer 41 to be about 1.5 or more times the second average particle diameter d2, even when the second average particle diameter d2 is about 3 μm that is the smallest, the thickness k of the coating layer 41 can be set to a value larger than the second average particle diameter d2 by about 1.5 μm. Thus, even when a high pressure is applied during the formation of the magnetic portion, it is possible to suppress the deterioration in insulation property of the coil 15.

On the other hand, as long as the insulation property of the coil 15 can be secured, it is preferable that the thickness k of the coating layer 41 is small. By suppressing the thickness k of the coating layer 41 to be small, density of the metal portion 40 in the coil 15 can be increased, and an outer shape of the coil can be made small, so that occupancy of the magnetic portion 20 in the inductor 100 can be increased. This makes it possible to improve the characteristics of the inductor 100 including the coil 15 and the magnetic portion 20. Even when a safety factor is taken into account, considering the characteristics of the inductor 100, it can be said that it is preferable to suppress the thickness k of the coating layer 41 to be within a range of about 2 to about 2.5 times the second average particle diameter d2.

When the above is comprehensively determined, the thickness k of the coating layer 41 is preferably within a range of about 1.5 or more and about 2.5 or less (i.e., from about 1.5 to about 2.5) times the second average particle diameter d2, and more preferably within a range of about 1.5 or more and about 2 or less (i.e., from about 1.5 to about 2) times the second average particle diameter d2. By setting the thickness k of the coating layer 41 within such a range, it is possible to obtain an inductor having a sufficient insulation property and excellent characteristics.

### Example

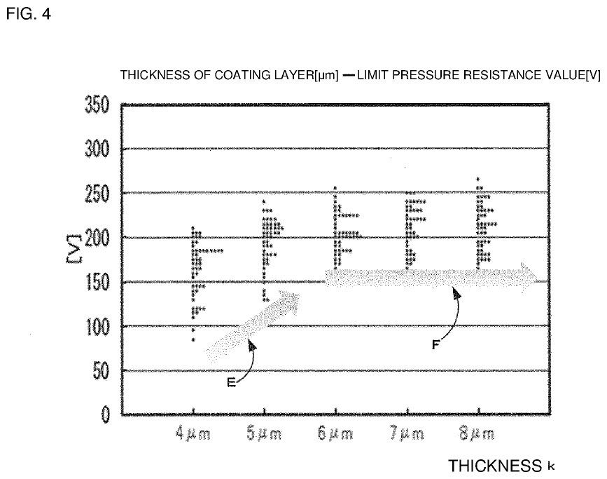

Next, with reference to FIG. 4, a working example will be described in which the inductor according to the embodiment is manufactured and tested. FIG. 4 is a graph illustrating the working example of the present disclosure, and is a graph showing a relationship between thickness and limit pressure resistance value (dielectric strength voltage) of a coating layer. A horizontal axis in FIG. 4 represents the thickness (μm) of the coating layer of the manufactured inductor, and a vertical axis represents the limit pressure resistance value (V) that is a test result of the manufactured inductor.

In the present working example, as the first particles P1 forming a magnetic portion, particles having the first average particle diameter d1 of about 50 μm were used, and as the second particles P2, particles having the second average particle diameter d2 of about 5 μm were used. In addition, inductors were manufactured by using rectangular wires having the thickness k of the coating layer of about 4 μm, about 5 μm, about 6 μm, about 7 μm, and about 8 μm, respectively, and measurement of the limit pressure resistance values was performed. A point indicated by * as a test result is plotted at a position in the graph corresponding to the thickness of the coating layer of each sample of the inductor and the limit pressure resistance value measured.

As indicated by an arrow E in the graph, it was clarified that the limit pressure resistance value of the inductor rises as the thickness k of the coating layer increases from about 4 μm that is smaller than the second average particle diameter d2, to about 5 μm that is the second average particle diameter d2, and when the thickness k of the coating layer is about 5 μm, a sufficient limit pressure resistance value was obtained. On the other hand, as indicated by an arrow F in the graph, it was clarified that, even when the thickness k of the coating layer was made larger than about 5 μm that is the second average particle diameter d2, there was no large change in the average value of the limit pressure resistance values.

As described above, it was demonstrated that when the thickness k of the coating layer has a value larger than the second average particle diameter d2, it is possible to suppress the deterioration in insulation property of the coil. Further, it was demonstrated that it is possible to manufacture an inductor having sufficient pressure resistance at a high yield, without providing an excessively thick coating layer.

Although the embodiment and mode of the present disclosure have been described, the disclosure may be changed in details of the configuration, and a combination of elements, a change in an order, and the like in the embodiment and mode may be realized without departing from the scope and spirit of the disclosure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An inductor, comprising:
a coil having a winding portion in which a conductor having a coating layer is wound, and a pair of lead-out portions in which the conductor is led out from the winding portion; and
a magnetic portion including magnetic powder and resin and configured to embed the coil, wherein
the magnetic powder includes first particles having a first average particle diameter, and second particles having a second average particle diameter smaller than the first average particle diameter, and
a thickness of the coating layer has a value larger than the second average particle diameter.

2. The inductor according to claim 1, wherein
the thickness of the coating layer has a value larger than the second average particle diameter by 1 μm or more.

3. The inductor according to claim 1, wherein
the thickness of the coating layer has a value larger than the second average particle diameter by 2 μm or more.

4. The inductor according to claim 1, wherein
the thickness of the coating layer is in a range of from 1.5 to 2.5 times the second average particle diameter.

5. The inductor according to claim 1, wherein
the conductor is a flat rectangular wire.

6. The inductor according to claim 2, wherein
the conductor is a flat rectangular wire.

7. The inductor according to claim 3, wherein
the conductor is a flat rectangular wire.

8. The inductor according to claim 4, wherein
the conductor is a flat rectangular wire.
